(19) United States
(12) Patent Application Publication
(10) Pub. No.: US 2014/0072068 A1
(43) Pub. Date: Mar. 13, 2014

(54) ENHANCED PERFORMANCE MULTI-USER MULTIPLE INPUT OUTPUT (MU-MIMO) RADIO LINKS

(71) Applicants: Yuan Zhu, Chao Yang District (CN); Qinghua Li, San Ramon, CA (US); Xiaogang Chen, Beijing (CN)

(72) Inventors: Yuan Zhu, Chao Yang District (CN); Qinghua Li, San Ramon, CA (US); Xiaogang Chen, Beijing (CN)

(21) Appl. No.: 13/995,167

(22) PCT Filed: Sep. 30, 2011
(86) PCT No.: PCT/US11/54449

§ 371 Date: Nov. 27, 2013

(51) Int. Cl. H04B 7/04; H04L 25/03

(52) U.S. Cl. CPC H04B 7/0452; H04L 25/03866; H04L 25/03898
USPC 375/267

(57) ABSTRACT

Technology is described for enhancing performance of multi-user multiple input multiple output (MU-MIMO) radio links. A system can include a scrambling module to scramble coded bits in codewords to be transmitted in a transmission. A modulation mapper can modulate the scrambled coded bits to generate modulation symbols in the transmission. A precoding module can precode modulation symbols for the transmission. A feedback module using a codebook with an increased number of codewords can be used to reduce a channel state information (CSI) quantization error in a transmission from a plurality of antennas coupled to the precoding module and configured to transmit the precoded transmission to multiple users.

### CLAIM OF PRIORITY

Priority to U.S. Provisional patent application Ser. No. 61/471,042 filed on Apr. 1, 2011 is claimed.

### BACKGROUND

As multimedia communications have become more popular for mobile electronic devices, mobile electronic device users have increasingly desired reliable high data rate transmissions. Multi-user multiple input multiple output (MU-MIMO) can be used to meet the demand for higher data rates and better improved wireless coverage even without increasing average transmit power or frequency bandwidth because the MU-MIMO structure uses multiple spatial layers to deliver multiple data streams using a given frequency-time resource.

MU-MIMO is a radio communication technique using a transmitter and receivers that each have multiple antennas to wirelessly communicate with one another. Using multiple antennas at the transmitter and receivers allows the spatial dimension to be applied to improve the performance and throughput of a wireless link. MIMO communication can be performed in an open loop or closed loop technique. A transmitter using the open loop MIMO technique has minimal knowledge of the channel condition before signals are transmitted to a receiver. In contrast, closed loop MIMO can feed back channel-related information from the transmitter to the receiver to allow the transmitter to modify transmit signals before the signals are transmitted to better match channel state conditions. The amount of feed-back information that is delivered from a receiver to a transmitter in a system using closed loop MIMO can be very large. The ability to increase the transmission quality of the feedback channel in a closed loop MIMO system can be useful.

### BRIEF DESCRIPTION OF THE DRAWINGS

FIG. 1 is a block diagram illustrating an example of a system with a transmitter and multiple receiver configuration for the radio links.

FIG. 2 is a block diagram illustrating an example system for enhancing performance of multi-user multiple input multiple output (MU-MIMO) radio links.

FIG. 3 is a chart illustrating an example of the PMI (Precoding Matrix Indicator) distribution for closely spaced ULA antenna.

FIG. 4 is a chart illustrating an example PMI distribution for a closely spaced cross polarization (XPol) antenna.

FIG. 5 illustrates an example PMI distribution for widely spaced cross-polarization (XPol) antenna.

FIG. 6 illustrates an example method for enhancing performance of multi-user multiple input multiple output (MU-MIMO) radio links.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

MU-MIMO (multiuser multiple input multiple output) is a form of MIMO that uses multiple independent radio terminals in order to enhance the communication capabilities of the individual terminals. MU-MIMO allows a terminal to transmit or receive signals between the terminal and multiple users or multiple devices in the same band simultaneously. MU-MIMO can leverage multiple users as spatially distributed transmission resources by using additional signal processing power. MU-MIMO can enhance MIMO systems where there are multiple users or connections.

Enhancements to the existing MU-MIMO (multiuser multiple input multiple output) specification have been discussed in LTE-A (Long Term Evolution-Advanced) Release 10 documents. Proposals have been made to enhance the Release 8 codebook to improve MU-MIMO performance. Most of these prior proposals fall into two categories: exploiting the time/frequency correlation to reduce the channel state information (CSI) quantization error or exploiting spatial domain correlation to reduce the CSI quantization error. Some proposals are a hybrid of those two categories. Because of the diverse views on the subject, no proposal on CSI quantization error reduction has been agreed to for the Release 10 time frame. Other enhancement directions for CQI/PMI (Channel Quality Indication/Precoding Matrix Indicator) have also been proposed, such as MU-CQI (Multiuser Channel Quality Indication), sub-band PMI and rank restricted PMI. Unfortunately, there is no consensus on the achievable gains from those proposals. Thus, the existing 4Tx (four transmitter) feedback performance currently remains the same as in 3GPP LTE-A Release 8.

During the discussion of 3GPP LTE-A Release 10, many communication network operators indicated that 4Tx remains a useful antenna configuration for practical deployment in mobile electronic devices. As compared to the 8Tx (eight transmitter) codebook defined in Release 10, which is composed of 4Tx DFT (Discrete Fourier Transform) vectors and co-phasing between two 4Tx components, the 4Tx codebook has a lower angular resolution. For example, the rank 1 4Tx codebook has only 8 DFT vectors. However, the 4Tx component of the 8Tx codebook has 32 DFT vectors. In general, a 5-10% SE (Spectral Efficiency) gain can be observed in MU-MIMO when the quantization error of the 4Tx codebook is improved, particularly for rank 1 and rank 2. If joint scheduling of SU-MIMO (single user multiple input multiple output) is considered, similar SE gain may be achieved as well.

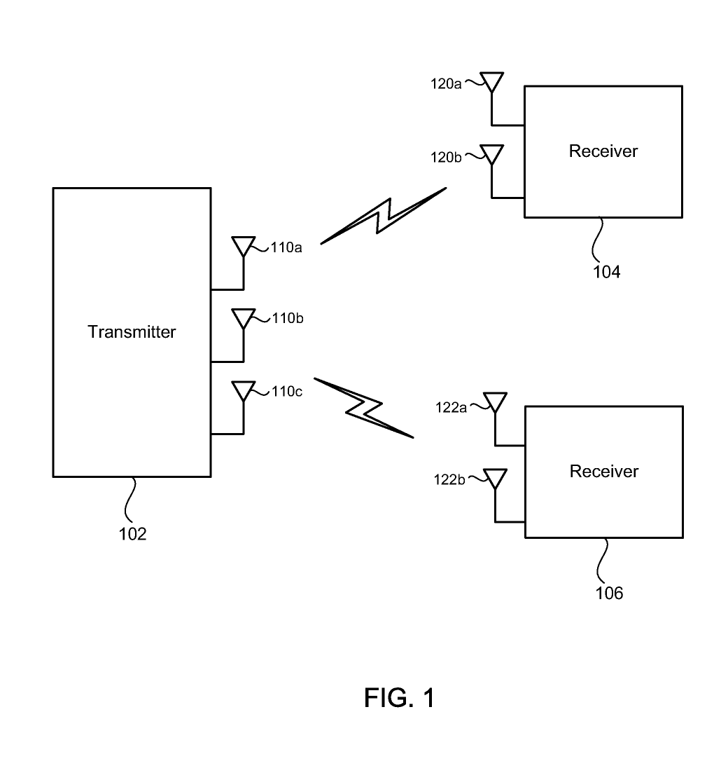

FIG. 1 illustrates a MU-MIMO system with a multiple transmitter and receiver configuration for the radio links. These types of systems can use multicarrier communication for transmitting data by dividing the data into narrow-band sub-carriers or tones. An example of a multi-carrier technique is orthogonal frequency division multiplexing (OFDM) in which the multiple sub-carriers are orthogonal to each other. The block diagram in FIG. 1 illustrates example wireless communication links in a MU-MIMO system.

A wireless transmitter 102 can communicate with wireless receivers 104, 106 via wireless channels. The transmitter 102 can have multiple transmit antennas 110a-c and each receiver can have two or more receive antennas 120a-b and 122a-b. Each wireless channel can be a MIMO channel. When using multicarrier communication, each of the transmit antennas may have a corresponding multicarrier transmitter associated with the transmitter. While two or three antennas are illustrated for the transmitter and receivers, the MIMO system can include the use of two or more transmitters for both the transmitter and the receivers. An MU-MIMO system can also include multiple transceivers that each use only a single antenna.

The wireless links of FIG. 1 can use a “closed loop” MIMO communication scheme. A receiver 104 may communicate channel-related feedback information to the transmitter 102 for use by the transmitter in developing more effective transmission signals. The antennas used for the forward direction link can be used by the reversed direction link or separate antennas can be used for the reverse direction link. For example, one method of developing channel-related feedback uses singular value decomposition (SVD). Various antenna types can be used by the transmitter 102 and the receiver 104, including: dipoles, patches, helical antennas, antenna arrays, and combinations of the listed antennas.

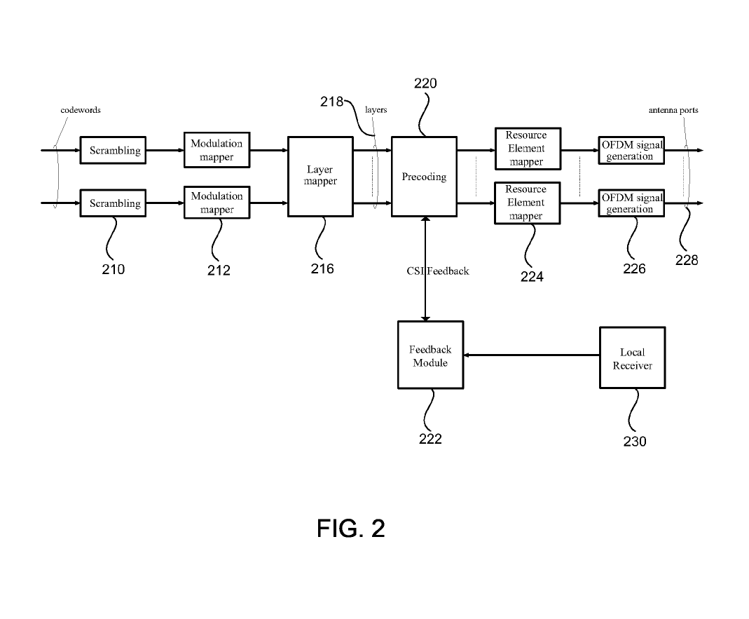

FIG. 2 illustrates an example system for enhancing performance of MU-MIMO radio links. The technology described in FIG. 2 is a general structure that is applicable to more than one physical channel. The baseband signal representing a downlink physical channel can be defined using the following operations occurring in the described modules. The system can include a scrambling module 210 to scramble coded bits in codewords to be transmitted in a transmission (e.g., over a physical channel). Using information about the channel, the transmitter can tailor the transmit signal to the channel in a manner that simplifies or improves receiver processing. The receiver can generate the channel-related feedback information by processing training signals received from the transmitter.

A modulation mapper 212 can be provided to modulate the scrambled coded bits to generate modulation symbols in the transmission. These modulation symbols generated can be complex-valued modulation symbols. Different types of modulation may be used including bi-phase shift keying (BPSK), quadrature phase shift keying (QPSK) quadrature amplitude modulation (QAM), 8-QAM, 16-QAM, 64-QAM, and so forth. The type of modulation used may depend on the signal quality. A layer mapper 216 can then map the complex-valued modulation symbols onto one or several transmission layers 218.

A precoding module 220 can then precode modulation symbols for the transmission. For example, the precoding can encode the complex-valued modulation symbols on each layer for transmission on the antenna ports. Precoding can be used to convert the antenna domain signal processing into the beam-domain processing. In addition, the antenna ports can also be coupled to a plurality of antennas. The transmit precoder can be chosen from a finite set of precoding matrices, called a codebook, that is known to both the receiver and the transmitter stations. A feedback module 222 can reduce channel state information (CSI) quantization error in a transmission from a plurality of antennas coupled to the precoding module using a codebook. The amount of CSI quantization error can depend on the size of the codebook. Adding additional codewords to the codebook, which have been formatted for specific types of antennas and antenna configurations, can significantly reduce the amount of CSI quantization error. The MU-MIMO system performance and overall communication channel can be improved by reducing the CSI quantization error. The feedback module in the receiver can select a desirable precoder from the codebook with a selection criterion based on the current channel state information (CSI) as received through a local receiver 230, and report back the index of the precoder in the matrix to the transmitter over the limited feedback channel. The number of additional codewords and the formatting of the codewords to reduce the CSI quantization error will be discussed more fully below.

A resource element mapper 224 can be used to map complex-valued modulation symbols for each antenna port to the available resource elements, An OFDM signal generation module 226 can then generate a complex-valued time-division duplex (TDD) or frequency division duplex (FDD) OFDM signal for each antenna port 228.

The precoded transmission can then be transmitted to multiple users by sending the precoded transmission to the antenna ports. Specifically, the precoded transmission can be transmitted to multiple users using a plurality of antennas coupled to the antenna ports.

In a MU-MIMO communication system, significant throughput gains can be obtained by closed-loop operation. At least two aspects of the transmission can be adapted to channel conditions: the transmission rank (number of independent spatial layers), and the precoding matrix which maps the spatial layers to the transmit antennas. To facilitate feedback and signaling, the precoding matrix for each rank is often restricted to a finite pre-determined codebook.

In order to reduce the channel state information (CSI) quantization error in a transmission, a codebook with an increased number of codewords can be used. More specifically, the codebook used in this technology can have an increased number of codewords as compared to a four transmitter (4Tx) codebook. For example, the codebook can have more than 32 codebook entries. In increasing the number of codebook entries, there also is a corresponding increase in a number of bits representing entries in the codebook from the existing 4 bits up to 5 bits or 6 bits.

These additional codebook entries can include entries to jointly address: closely spaced ULA (Uniform Linear Array) antennas, closely spaced cross polarization (XPol) antennas, largely spaced cross polarization antennas, and geographically separated antennas. Some of the additional entries to the codebook can include additional DFT (Discrete Fourier Transform) vectors. For example, additional DFT (Discrete Fourier Transform) vectors can be added to the existing 4Tx (four transmitter) codebook for communication with closely spaced U LA (Uniform Linear Array) antennas and closely spaced cross polarization antennas. As another example, additional non-DFT (non-Discrete Fourier Transform) vectors can be added to the existing 4Tx codebook to improve performance of communication with closely spaced cross polarization antennas.

A non-constant modulus codeword can also be added to the codebook for largely spaced cross polarization antennas or geographically separated antennas. An example of a non-constant modulus codeword that can be used is [1 1 0 0]^{T}, where T is a transpose of the matrix. The use of a non-constant modulus codeword for geographically separated antennas can also be applied to other numbers of Tx antennas, such as for 2Tx (i.e., two transmitters) [1 0]^{T} and [0 1]^{T} can be added.

The present configuration or defined standard for closed loop MIMO communication provides for 4 bits of PMI information in the CQI. In order to accommodate the additional bits needed to allow the use of more than 32 codewords, space can be provided for the transmission of the two most significant bits. In one configuration, six bits can be transmitted as a precoding matrix indicator (PMI) to identify an entry in the codebook for each codeword. The two most significant bits of the six bits can be transmitted with an RI (rank indicator) and a remaining four bits can be transmitted as a PMI in a channel quality indication (CQI) on a physical uplink control channel.

In order to change the existing codebook and increase the number of codewords, the specification for 3GPP TS 36.211 (i.e., LTE-A) can be modified. The increased PMI bits can have an impact on UCI (uplink control information) definitions and encoding in specification 36.212. If one report, such as the CQI report, exceeds the payload limit because of the bigger PMI size, special treatments can be used, such as the inclusion of the additional information in the RI report. A codebook update can result in many changes in the specification and spread across multiple specifications.

In order to update the Release 8 codebook (e.g. to add more codewords), certain designs can be used such as the adding of a constant modulus and finite alphabet for consensus. However, this approach may be less effective for the widely spaced 4Tx X-Pol (cross polarization) antennas. In this configuration, a non-constant modulus codebook can have some benefits. The addition of non-constant modulus codewords in the codebook can result in better throughput gain for widely spaced X-Pol antennas.

In Release 8, the 4Tx codebook is constructed as a table by expanding vectors to square matrixes and then selecting columns from the matrixes. First, 16 4×1 vectors (i.e. u₀ to u₁₅) are chosen, then 16 4×4 matrices W₀ to W₁₅ are constructed from the 16 vectors as Wₙ=1−2uₙuₙ^{H}|uₙ^{H}uₙ. This equation is called the Householder reflection. The four columns in matrix Wₙ are orthogonal to each other. The rank 1 to rank 4 codeword is formed by selecting columns from the square matrix Wₙ. For example, the rank 1 codebook picks the first column of all Wₙ. In addition, the rank 2 codebook picks the first column and one of the rest columns. The modulus of each entry of the codeword uₙ can be a constant. This property is referred to as constant modulus. Another attribute is the nesting property. That is, a higher rank precoder for the same codebook index contains the columns for the same codebook index with lower ranks. A major benefit of nesting is computational complexity savings for rank adaptation and robustness to RI (rank indicator) mismatch in the case of a periodical CQI report.

In Rel. 10, the 8Tx codebook optimizes the codebook performance assuming typical antenna configurations, such as 8Tx closely-spaced ULA and 8Tx closely-spaced XPol. Thus, the 8Tx codebook designing problem has been divided into designing a 4Tx codebook for closely spaced 4Tx ULA and a co-phasing between two sets of polarized antennas. For example, 32 4Tx DFT beams and 4 co-phasing values have been defined as below:

φₙ=e^{jπm/2}

vₘ=[1e^{j2πm/32}e^{j4πm/32}e^{j6πm/32}]^{T}

where vₘ when m is 0≦m<31 are the 4Tx DFT beams and φₙ when n is 0≦n<4 are the cophasing angles. In addition, for each rank, the codebook can be constructed from those two parameters. For example, the rank 1 8Tx codebook can be constructed as:

$${W}_{m , n}^{( 1 )} = \frac{1}{\sqrt{8}} [ \begin{matrix}{v}_{m} \\ {ϕ}_{n} {v}_{m}\end{matrix} ]$$

The principles discussed above can be used to extend the Release 8 4Tx codebook from 4 bits to 5 or 6 bits. From the perspective of improving MU-MIMO, the rank 1 and rank 2 codebooks can use the extensions. The higher rank codebook may be large enough for closed-loop MU-MIMO.

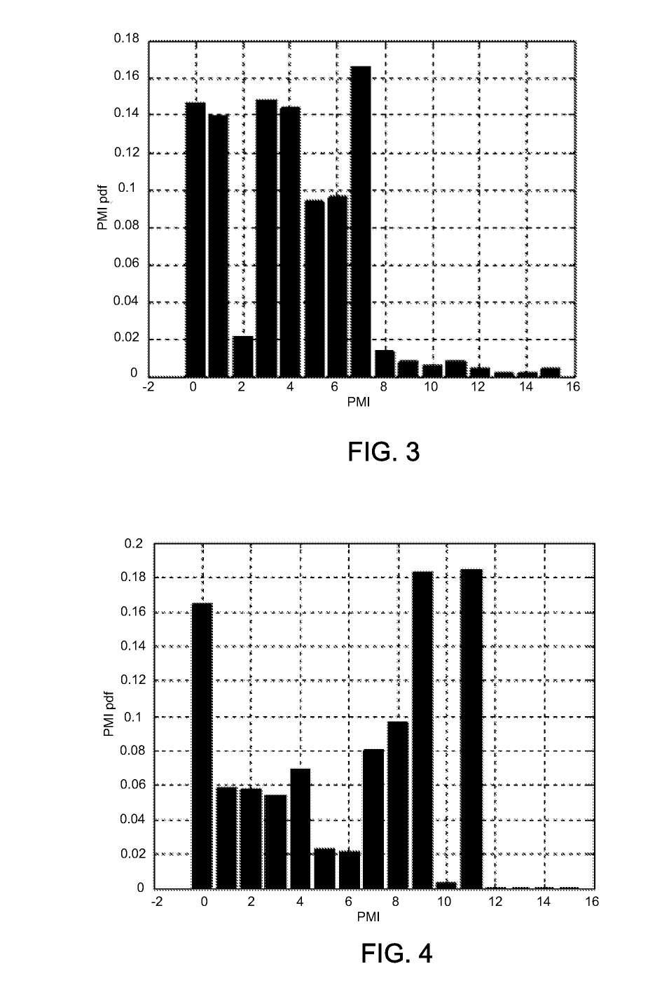

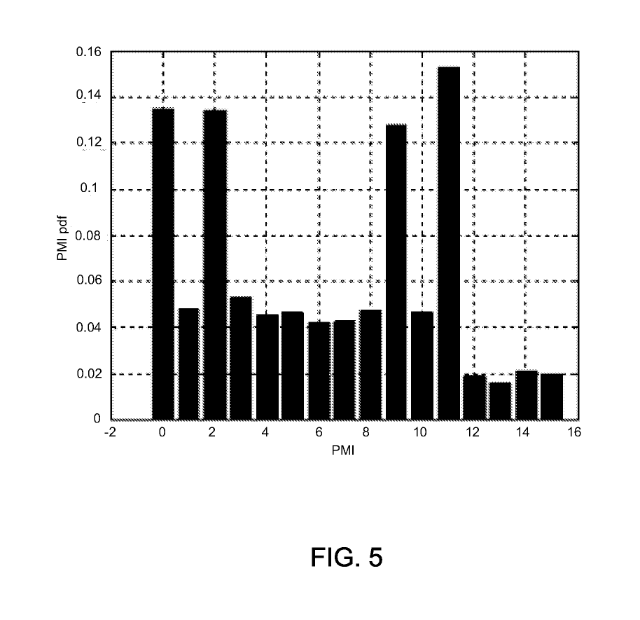

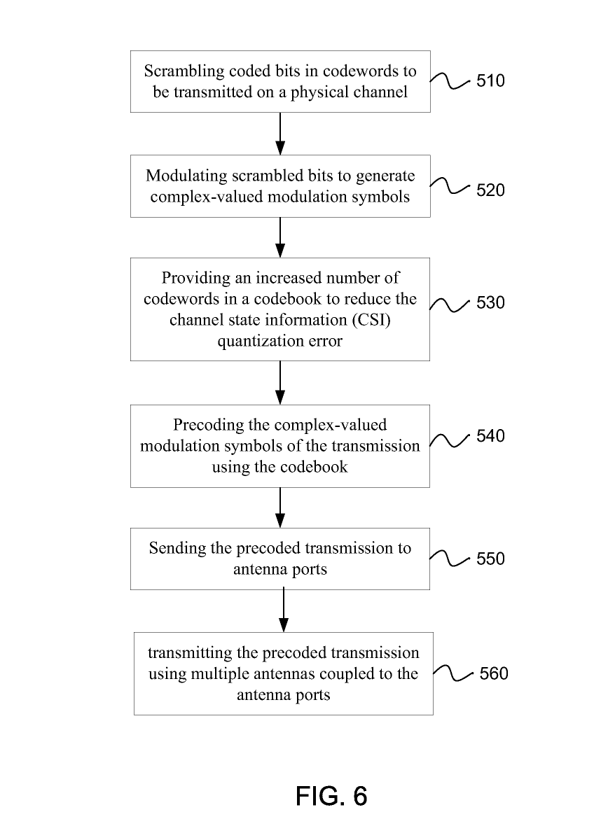

Previously, some design considerations for the Release 8 codebook were explained. The resultant rank-1 4-bit codebook can contain 8 DFT vectors and 8 non-DFT vectors. A DFT vector is more suitable for calibrated ULA antennas. FIG. 3 illustrates the PMI distribution for a closely spaced ULA antenna. In FIG. 3, the first 8 DFT vectors are used much more often than the remaining eight vectors. FIG. 4 is a chart illustrating the PMI distribution for a closely spaced cross polarization (XPol) antenna. It can be seen that in addition to the first 8 vectors, vectors 8 to 11 are also often used. FIG. 5 gives the PMI distribution for a widely spaced XPol (cross-polarization) antenna. In this case, each of the vectors will have some chance to be chosen, though the last four vectors still seem to have a smaller chance to be chosen.

Directional antennas can also be used. For example, in a ULA 0.5L antenna configuration the directional antennas may each have a 70 degree beam pointing to the antenna's broad side. Thus, the third vector [1 −1 1 −1]/2 is less likely to be used in a ULA 0.5L antenna configuration since the formed beam points to the end fire direction that is usually covered by the other collocated sectors. Similarly the tenth vector [1 −1 −1 1]/2 also has significantly less probability to be chosen in an XPol 0.5L antenna configuration.

In order to form a larger codebook that can be advantageous to frequently used antenna configurations, the rank 1 codebook can be extended. After the augmented rank-1 codebook is obtained, the rank-2 codebook can be extended using the design principles discussed with respect to the Release 8 4Tx codebook and/or the Release 10 8Tx codebook.

Table 1 is an example of extending a rank-1 codebook to 5 bits or 6 bits and extending a rank-2 codebook. If the 4Tx codebook is extended to 5 bits, 8 DFT vectors can be added, which are indexed from 16 to 23 and 8 non-DFT vectors can be added which are indexed from 24 to 31. The rank-2 codebook can be extended accordingly. For the first 8 DFT vectors, the corresponding rank-2 matrix can contain the rank-1 vector as the first column and one orthogonal rank-1 DFT vector as the second column. For the eight non-DFT vectors, the four rank-2 matrices can be extended. The first column of the rank-2 matrix is the same as the rank-1 vector having the same codebook index. The second column of the rank 2 matrix can rotate the third and fourth elements of the first column by 180 degrees, in which case the co-phasing of two transmitter (2Tx) polarization is 180 degrees. The four codewords unused in the rank 2 codebook can be reserved for other signaling purposes. Table 1 illustrates additional vectors for transmission on four antenna ports.

TABLE 1

| Code- | | |
|---|---|---|
| book | Number of layers ^{υ} | |
| index | 1 | 2 |
| 16 | v₂/2 | [v₂ v₁₀]/2\sqrt{2} |
| 17 | v₁₀/2 | [v₁₀ v₁₈]/2\sqrt{2} |
| 18 | v₁₈/2 | [v₁₈ v₂₆]/2\sqrt{2} |
| 19 | v₂₆/2 | [v₂₆ v₂]/2\sqrt{2} |
| 20 | v₆/2 | [v₆ v₁₄]/2\sqrt{2} |
| 21 | v₁₄/2 | [v₁₄ v₂₂]/2\sqrt{2} |
| 22 | v₂₂/2 | [v₂₂ v₃₀]/2\sqrt{2} |
| 23 | v₃₀/2 | [v₃₀ v₆]/2\sqrt{2} |
| 24 | [1 1 j j]^{T}/2 | ${[ \begin{matrix}1 & 1 & j & j \\ 1 & 1 & - j & - j\end{matrix} ]}^{T} \text{/} 2 \sqrt{2}$ |
| 25 | [1 j −j 1]^{T}/2 | ${[ \begin{matrix}1 & j & - j & 1 \\ 1 & j & j & - 1\end{matrix} ]}^{T} \text{/} 2 \sqrt{2}$ |
| 26 | [1 −1 j −j]^{T}/2 | ${[ \begin{matrix}1 & - 1 & j & - j \\ 1 & - 1 & - j & j\end{matrix} ]}^{T} \text{/} 2 \sqrt{2}$ |
| 27 | [1 −j −j −1]^{T}/2 | ${[ \begin{matrix}1 & - j & - j & - 1 \\ 1 & - j & j & 1\end{matrix} ]}^{T} \text{/} 2 \sqrt{2}$ |
| 28 | [1 1 −j −j]^{T}/2 | |
| 29 | [1 j j −1]^{T}/2 | |
| 30 | [1 −1 −j j]^{T}/2 | |
| 31 | [1 −j j 1]^{T}/2 | |
| 32 | v₁/2 | [v₁ v₉]/2\sqrt{2} |
| 33 | v₉/2 | [v₉ v₁₇]/2\sqrt{2} |
| 34 | v₁₇/2 | [v₁₇ v₂₅]/2\sqrt{2} |
| 35 | v₂₅/2 | [v₂₅ v₁]/2\sqrt{2} |
| 36 | v₅/2 | [v₅ v₁₃]/2\sqrt{2} |
| 37 | v₁₃/2 | [v₁₃ v₂₁]/2\sqrt{2} |
| 38 | v₂₁/2 | [v₂₁ v₂₉]/2\sqrt{2} |
| 39 | v₂₉/2 | [v₂₉ v₅]/2\sqrt{2} |
| 40 | v₃/2 | [v₁ v₉]/2\sqrt{2} |
| 41 | v₁₁/2 | [v₉ v₁₇]/2\sqrt{2} |
| 42 | v₁₉/2 | [v₁₇ v₂₅]/2\sqrt{2} |
| 43 | v₂₇/2 | [v₂₅ v₁]/2\sqrt{2} |
| 44 | v₇/2 | [v₇ v₁₅]/2\sqrt{2} |
| 45 | v₁₅/2 | [v₁₅ v₂₃]/2\sqrt{2} |
| 46 | v₂₂/2 | [v₂₃ v₃₁]/2\sqrt{2} |
| 47 | v₃₁/2 | [v₃₁ v₇]/2\sqrt{2} |
| 48 | ${[ \begin{matrix}1 & {e}^{j \frac{π}{4}} & - j & {e}^{- j \frac{π}{4}}\end{matrix} ]}^{T} \text{/} 2$ | ${[ \begin{matrix}1 & {e}^{j \frac{π}{4}} & - j & {e}^{- j \frac{π}{4}} \\ 1 & {e}^{j \frac{π}{4}} & j & - {e}^{- j \frac{π}{4}}\end{matrix} ]}^{T} \text{/} 2 \sqrt{2}$ |
| 49 | ${[ \begin{matrix}1 & {e}^{j \frac{3 π}{4}} & j & {e}^{j \frac{5 π}{4}}\end{matrix} ]}^{T} \text{/} 2$ | ${[ \begin{matrix}1 & {e}^{j \frac{3 π}{4}} & j & {e}^{j \frac{5 π}{4}} \\ 1 & {e}^{j \frac{3 π}{4}} & - j & - {e}^{j \frac{5 π}{4}}\end{matrix} ]}^{T} \text{/} 2 \sqrt{2}$ |
| 50 | ${[ \begin{matrix}1 & {e}^{j \frac{5 π}{4}} & - j & {e}^{j \frac{3 π}{4}}\end{matrix} ]}^{T} \text{/} 2$ | ${[ \begin{matrix}1 & {e}^{j \frac{5 π}{4}} & - j & {e}^{j \frac{3 π}{4}} \\ 1 & {e}^{j \frac{5 π}{4}} & j & - {e}^{j \frac{3 π}{4}}\end{matrix} ]}^{T} \text{/} 2 \sqrt{2}$ |
| 51 | ${[ \begin{matrix}1 & {e}^{- j \frac{π}{4}} & j & {e}^{j \frac{π}{4}}\end{matrix} ]}^{T} \text{/} 2$ | ${[ \begin{matrix}1 & {e}^{- j \frac{π}{4}} & j & {e}^{j \frac{π}{4}} \\ 1 & {e}^{- j \frac{π}{4}} & - j & - {e}^{j \frac{π}{4}}\end{matrix} ]}^{T} \text{/} 2 \sqrt{2}$ |
| 52 | ${[ \begin{matrix}1 & {e}^{j \frac{π}{4}} & 1 & {e}^{j \frac{π}{4}}\end{matrix} ]}^{T} \text{/} 2$ | ${[ \begin{matrix}1 & {e}^{j \frac{π}{4}} & 1 & {e}^{j \frac{π}{4}} \\ 1 & {e}^{- j \frac{π}{4}} & - 1 & - {e}^{j \frac{π}{4}}\end{matrix} ]}^{T} \text{/} 2 \sqrt{2}$ |
| 53 | ${[ \begin{matrix}1 & {e}^{j \frac{3 π}{4}} & - 1 & - {e}^{j \frac{3 π}{4}}\end{matrix} ]}^{T} \text{/} 2$ | ${[ \begin{matrix}1 & {e}^{j \frac{3 π}{4}} & - 1 & - {e}^{j \frac{3 π}{4}} \\ 1 & {e}^{j \frac{3 π}{4}} & 1 & {e}^{j \frac{3 π}{4}}\end{matrix} ]}^{T} \text{/} 2 \sqrt{2}$ |
| 54 | ${[ \begin{matrix}1 & {e}^{j \frac{5 π}{4}} & 1 & {e}^{j \frac{5 π}{4}}\end{matrix} ]}^{T} \text{/} 2$ | ${[ \begin{matrix}1 & {e}^{j \frac{5 π}{4}} & 1 & {e}^{j \frac{5 π}{4}} \\ 1 & {e}^{j \frac{5 π}{4}} & - 1 & - {e}^{j \frac{5 π}{4}}\end{matrix} ]}^{T} \text{/} 2 \sqrt{2}$ |
| 55 | ${[ \begin{matrix}1 & {e}^{- j \frac{π}{4}} & - 1 & - {e}^{- j \frac{π}{4}}\end{matrix} ]}^{T} \text{/} 2$ | ${[ \begin{matrix}1 & {e}^{- j \frac{π}{4}} & - 1 & - {e}^{- j \frac{π}{4}} \\ 1 & {e}^{- j \frac{π}{4}} & 1 & {e}^{- j \frac{π}{4}}\end{matrix} ]}^{T} \text{/} 2 \sqrt{2}$ |
| 56 | ${[ \begin{matrix}1 & {e}^{j \frac{π}{4}} & - 1 & - {e}^{j \frac{π}{4}}\end{matrix} ]}^{T} \text{/} 2$ | |
| 57 | ${[ \begin{matrix}1 & {e}^{j \frac{3 π}{4}} & 1 & {e}^{j \frac{3 π}{4}}\end{matrix} ]}^{T} \text{/} 2$ | |
| 58 | ${[ \begin{matrix}1 & {e}^{j \frac{5 π}{4}} & - 1 & - {e}^{j \frac{5 π}{4}}\end{matrix} ]}^{T} \text{/} 2$ | |
| 59 | ${[ \begin{matrix}1 & {e}^{- j \frac{π}{4}} & 1 & {e}^{- j \frac{π}{4}}\end{matrix} ]}^{T} \text{/} 2$ | |

Table 2 illustrates another example of providing additional vectors to extend the rank-1 and rank-2 codebook. This table applies to vectors for transmission using four antenna ports. First, the rank-1 vector can be unchanged as in Table 1. Second, uₙ can be recovered assuming the first column of Wₙ is already known. After that more columns are selected to create the rank-2 matrix.

TABLE 2

| Codebook | | Number of layers ^{υ} | |
|---|---|---|---|
| index | uₙ | 1 | 2 |
| 16 | u₁₆ = [1 −e^{j2π2/32} −e^{j4π2/32} −e^{j6π2/32}]^{T} | W₁₆^{{1}} | W₁₆^{{14}}/\sqrt{2} |
| 17 | u₁₇ = [1 −e^{j2π10/32} −e^{j4π10/32} −e^{j6π10/32}]^{T} | W₁₇^{{1}} | W₁₇^{{12}}/\sqrt{2} |
| 18 | u₁₈ = [1 −e^{j2π18/32} −e^{j4π18/32} −e^{j6π18/32}]^{T} | W₁₈^{{1}} | W₁₈^{{12}}/\sqrt{2} |
| 19 | u₁₉ = [1 −e^{j2π26/32} −e^{j4π26/32} −e^{j6π26/32}]^{T} | W₁₉^{{1}} | W₁₉^{{12}}/\sqrt{2} |
| 20 | u₂₀ = [1 −e^{j2π6/32} −e^{j4π6/32} −e^{j6π6/32}]^{T} | W₂₀^{{1}} | W₂₀^{{14}}/\sqrt{2} |
| 21 | u₂₁ = [1 −e^{j2π14/32} −e^{j4π14/32} −e^{j6π14/32}]^{T} | W₂₁^{{1}} | W₂₁^{{14}}/\sqrt{2} |
| 22 | u₂₂ = [1 −e^{j2π22/32} −e^{j4π22/32} −e^{j6π22/32}]^{T} | W₂₂^{{1}} | W₂₂^{{13}}/\sqrt{2} |
| 23 | u₂₃ = [1 −e^{j2π30/32} −e^{j4π30/32} −e^{j6π30/32}]^{T} | W₂₃^{{1}} | W₂₃^{{13}}/\sqrt{2} |
| 24 | u₂₄ = [1 −1 −j −j]^{T} | W₂₄^{{1}} | W₂₄^{{12}}/\sqrt{2} |
| 25 | u₂₅ = [1 −j j −1]^{T} | W₂₅^{{1}} | W₂₅^{{14}}/\sqrt{2} |
| 26 | u₂₆ = [1 1 −j j]^{T} | W₂₆^{{1}} | W₂₆^{{13}}/\sqrt{2} |
| 27 | u₂₇ = [1 j j 1]^{T} | W₂₇^{{1}} | W₂₇^{{13}}/\sqrt{2} |
| 28 | u₂₈ = [1 −1 j j]^{T} | W₂₈^{{1}} | W₂₈^{{12}}/\sqrt{2} |
| 29 | u₂₉ = [1 −j −j 1]^{T} | W₂₉^{{1}} | W₂₉^{{13}}/\sqrt{2} |
| 30 | u₃₀ = [1 1 j −j]^{T} | W₃₀^{{1}} | W₃₀^{{13}}/\sqrt{2} |
| 31 | u₃₁ = [1 j −j −1]^{T} | W₃₁^{{1}} | W₃₁^{{12}}/\sqrt{2} |
| 32 | u₃₂ = [1 −e^{j2π/32} −e^{j4π/32} −e^{j6π/32}]^{T} | W₃₂^{{1}} | W₃₂^{{14}}/\sqrt{2} |
| 33 | u₃₃ = [1 −e^{j2π9/32} −e^{j4π9/32} −e^{j6π9/32}]^{T} | W₃₃^{{1}} | W₃₃^{{12}}/\sqrt{2} |
| 34 | u₃₄ = [1 −e^{j2π17/32} −e^{j4π17/32} −e^{j6π17/32}]^{T} | W₃₄^{{1}} | W₃₄^{{12}}/\sqrt{2} |
| 35 | u₃₅ = [1 −e^{j2π25/32} −e^{j4π25/32} −e^{j6π25/32}]^{T} | W₃₅^{{1}} | W₃₅^{{12}}/\sqrt{2} |
| 36 | u₃₆ = [1 −e^{j2π5/32} −e^{j4π5/32} −e^{j6π5/32}]^{T} | W₃₆^{{1}} | W₃₆^{{14}}/\sqrt{2} |
| 37 | u₃₇ = [1 −e^{j2π13/32} −e^{j4π13/32} −e^{j6π13/32}]^{T} | W₃₇^{{1}} | W₃₇^{{14}}/\sqrt{2} |
| 38 | u₃₈ = [1 −e^{j2π21/32} −e^{j4π21/32} −e^{j6π21/32}]^{T} | W₃₈^{{1}} | W₃₈^{{13}}/\sqrt{2} |
| 39 | u₃₉ = [1 −e^{j2π29/32} −e^{j4π29/32} −e^{j6π29/32}]^{T} | W₃₉^{{1}} | W₃₉^{{13}}/\sqrt{2} |
| 40 | u₄₀ = [1 −e^{j2π3/32} −e^{j4π3/32} −e^{j6π3/32}]^{T} | W₄₀^{{1}} | W₄₀^{{12}}/\sqrt{2} |
| 41 | u₄₁ = [1 −e^{j2π11/32} −e^{j4π11/32} −e^{j6π11/32}]^{T} | W₄₁^{{1}} | W₄₁^{{14}}/\sqrt{2} |
| 42 | u₄₂ = [1 −e^{j2π19/32} −e^{j4π19/32} −e^{j6π19/32}]^{T} | W₄₂^{{1}} | W₄₂^{{13}}/\sqrt{2} |
| 43 | u₄₃ = [1 −e^{j2π27/32} −e^{j4π27/32} −e^{j6π27/32}]^{T} | W₄₃^{{1}} | W₄₃^{{13}}/\sqrt{2} |
| 44 | u₄₄ = [1 −e^{j2π7/32} −e^{j4π7/32} −^{ej6π7/32}]^{T} | W₄₄^{{1}} | W₄₄^{{12}}/\sqrt{2} |
| 45 | u₄₅ = [1 −e^{j2π15/32} −e^{j4π15/32} −e^{j6π15/32}]^{T} | W₄₅^{{1}} | W₄₅^{{13}}/\sqrt{2} |
| 46 | u₄₆ = [1 −e^{j2π23/32} −e^{j4π23/32} −e^{j6π23/32}]^{T} | W₄₆^{{1}} | W₄₆^{{13}}/\sqrt{2} |
| 47 | u₄₇ = [1 −e^{j2π31/32} −e^{j4π31/32} −e^{j6π31/32}]^{T} | W₄₇^{{1}} | W₄₇^{{12}}/\sqrt{2} |
| 48 | ${u}_{48} = {[ \begin{matrix}1 & - {e}^{j \frac{π}{4}} & j & - {e}^{- j \frac{π}{4}}\end{matrix} ]}^{T}$ | W₄₈^{{1}} | W₄₈^{{13}}/\sqrt{2} |
| 49 | ${u}_{49} = {[ \begin{matrix}1 & - {e}^{j \frac{3 π}{4}} & - j & - {e}^{j \frac{5 π}{4}}\end{matrix} ]}^{T}$ | W₄₉^{{1}} | W₄₉^{{12}}/\sqrt{2} |
| 50 | ${u}_{50} = {[ \begin{matrix}1 & - {e}^{j \frac{5 π}{4}} & j & - {e}^{j \frac{3 π}{4}}\end{matrix} ]}^{T}$ | W₅₀^{{1}} | W₅₀^{{13}}/\sqrt{2} |
| 51 | ${u}_{51} = {[ \begin{matrix}1 & - {e}^{- j \frac{π}{4}} & - j & - {e}^{j \frac{π}{4}}\end{matrix} ]}^{T}$ | W₅₁^{{1}} | W₅₁^{{12}}/\sqrt{2} |
| 52 | ${u}_{52} = {[ \begin{matrix}1 & - {e}^{j \frac{π}{4}} & - 1 & - {e}^{j \frac{π}{4}}\end{matrix} ]}^{T}$ | W₅₂^{{1}} | W₅₂^{{13}}/\sqrt{2} |
| 53 | ${u}_{53} = {[ \begin{matrix}1 & - {e}^{j \frac{3 π}{4}} & 1 & {e}^{j \frac{3 π}{4}}\end{matrix} ]}^{T}$ | W₅₃^{{1}} | W₅₃^{{12}}/\sqrt{2} |
| 54 | ${u}_{54} = {[ \begin{matrix}1 & - {e}^{j \frac{5 π}{4}} & - 1 & - {e}^{j \frac{5 π}{4}}\end{matrix} ]}^{T}$ | W₅₄^{{1}} | W₅₄^{{12}}/\sqrt{2} |
| 55 | ${u}_{55} = {[ \begin{matrix}1 & - {e}^{- j \frac{π}{4}} & 1 & {e}^{- j \frac{π}{4}}\end{matrix} ]}^{T}$ | W₅₅^{{1}} | W₅₅^{{13}}/\sqrt{2} |
| 56 | ${u}_{56} = {[ \begin{matrix}1 & - {e}^{j \frac{π}{4}} & 1 & {e}^{j \frac{π}{4}}\end{matrix} ]}^{T}$ | W₅₆^{{1}} | W₅₆^{{12}}/\sqrt{2} |
| 57 | ${u}_{57} = {[ \begin{matrix}1 & - {e}^{j \frac{3 π}{4}} & - 1 & - {e}^{j \frac{3 π}{4}}\end{matrix} ]}^{T}$ | W₅₇^{{1}} | W₅₇^{{13}}/\sqrt{2} |
| 58 | ${u}_{58} = {[ \begin{matrix}1 & - {e}^{j \frac{5 π}{4}} & 1 & {e}^{j \frac{5 π}{4}}\end{matrix} ]}^{T}$ | W₅₈^{{1}} | W₅₈^{{12}}/\sqrt{2} |
| 59 | ${u}_{59} = {[ \begin{matrix}1 & - {e}^{- j \frac{π}{4}} & - 1 & - {e}^{- j \frac{π}{4}}\end{matrix} ]}^{T}$ | W₅₉^{{1}} | W₅₉^{{12}}/\sqrt{2} |

The increased PMI (Precoding Matrix Indicator) bits can cause some CQI (Channel Quality Indication) report types to exceed the 11-bit PUCCH (Physical Uplink Control Channel) payload limit. The overflow situation is mainly in the rank-2 case since LTE will start transmitting two TB (transport blocks) from rank-2 up to higher ranks. In the PUCCH 1-1 case, the rank-2 wideband PMI/CQI report can use 4-bits of PMI data plus 4-bits of CQI data for the first TB and 3-bits of differential CQI for the second TB in Release 8. If rank-2 PMI increases to 5 bits or 6 bits, one way to send the bits is to mark the most significant rank bits together with the RI (rank indicator). The PUCCH 2-1 case is similar.

The extension method described above can employ a design structure that uses DFT plus co-phase. This structure can be removed while keeping the properties of a constant modulus and a finite alphabet (32- or 16-PSK in Rel 10) for designing the new codebook. A search can be performed to find the optimal codebook that maximizes the throughput of the radio link while using the two properties. An optimized example of the rank-1 and rank-2 codebooks using the two properties described are listed in Table 3. In these codebooks, column nesting is extended to codebook nesting. For reducing the computational complexity in selecting a codebook for 4-bit, 5-bit, and 6-bit indexed tables and in selecting a codeword, the smaller codebook may be a subset of the larger one. The codebook nesting trades off performance for complexity reduction.

Table 3 illustrates an example of extended codewords for 4Tx antenna ports with 32-PSK constellation. For rank-2, the codewords listed in the table can be divided by the square root of 2 for power normalization. The rank-2 codeword has appended one additional column as listed in the table to maintain the nesting structure.

TABLE 3

| Code- | | |
|---|---|---|
| book | Number of layers^{υ} | |
| index | 1 | 2 |
| 16 | ${\frac{1}{2} [ \begin{matrix}1 & {e}^{j \frac{2 π}{16}} & {e}^{j \frac{4 π}{16}} & {e}^{j \frac{6 π}{16}}\end{matrix} ]}^{T}$ | ${\frac{1}{2} [ \begin{matrix}1 & {e}^{j \frac{8 π}{16}} & {e}^{j \frac{20 π}{16}} & {e}^{j \frac{28 π}{16}}\end{matrix} ]}^{T}$ |
| 17 | ${\frac{1}{2} [ \begin{matrix}1 & {e}^{j \frac{10 π}{16}} & {e}^{j \frac{20 π}{16}} & {e}^{j \frac{29 π}{16}}\end{matrix} ]}^{T}$ | ${\frac{1}{2} [ \begin{matrix}1 & {e}^{j \frac{26 π}{16}} & {e}^{j \frac{29 π}{16}} & {e}^{j \frac{22 π}{16}}\end{matrix} ]}^{T}$ |
| 18 | ${\frac{1}{2} [ \begin{matrix}1 & {e}^{j \frac{18 π}{16}} & {e}^{j \frac{2 π}{16}} & {e}^{j \frac{22 π}{16}}\end{matrix} ]}^{T}$ | ${\frac{1}{2} [ \begin{matrix}1 & {e}^{j \frac{25 π}{16}} & {e}^{j \frac{18 π}{16}} & {e}^{j \frac{13 π}{16}}\end{matrix} ]}^{T}$ |
| 19 | ${\frac{1}{2} [ \begin{matrix}1 & {e}^{j \frac{26 π}{16}} & {e}^{j \frac{20 π}{16}} & {e}^{j \frac{14 π}{16}}\end{matrix} ]}^{T}$ | ${\frac{1}{2} [ \begin{matrix}1 & {e}^{j \frac{31 π}{16}} & {e}^{j \frac{4 π}{16}} & {e}^{j \frac{3 π}{16}}\end{matrix} ]}^{T}$ |
| 20 | ${\frac{1}{2} [ \begin{matrix}1 & {e}^{j \frac{6 π}{16}} & {e}^{j \frac{12 π}{16}} & {e}^{j \frac{18 π}{16}}\end{matrix} ]}^{T}$ | ${\frac{1}{2} [ \begin{matrix}1 & {e}^{j \frac{0 π}{16}} & {e}^{j \frac{22 π}{16}} & {e}^{j \frac{2 π}{16}}\end{matrix} ]}^{T}$ |
| 21 | ${\frac{1}{2} [ \begin{matrix}1 & {e}^{j \frac{14 π}{16}} & {e}^{j \frac{28 π}{16}} & {e}^{j \frac{10 π}{16}}\end{matrix} ]}^{T}$ | ${\frac{1}{2} [ \begin{matrix}1 & {e}^{j \frac{30 π}{16}} & {e}^{j \frac{30 π}{16}} & {e}^{j \frac{28 π}{16}}\end{matrix} ]}^{T}$ |
| 22 | ${\frac{1}{2} [ \begin{matrix}1 & {e}^{j \frac{22 π}{16}} & {e}^{j \frac{12 π}{16}} & {e}^{j \frac{2 π}{16}}\end{matrix} ]}^{T}$ | ${\frac{1}{2} [ \begin{matrix}1 & {e}^{j \frac{6 π}{16}} & {e}^{j \frac{5 π}{16}} & {e}^{j \frac{11 π}{16}}\end{matrix} ]}^{T}$ |
| 23 | ${\frac{1}{2} [ \begin{matrix}1 & {e}^{j \frac{30 π}{16}} & {e}^{j \frac{28 π}{16}} & {e}^{j \frac{26 π}{16}}\end{matrix} ]}^{T}$ | ${\frac{1}{2} [ \begin{matrix}1 & {e}^{j \frac{29 π}{16}} & {e}^{j \frac{11 π}{16}} & {e}^{j \frac{10 π}{16}}\end{matrix} ]}^{T}$ |
| 24 | ${\frac{1}{2} [ \begin{matrix}1 & {e}^{j \frac{30 π}{16}} & {e}^{j \frac{8 π}{16}} & {e}^{j \frac{7 π}{16}}\end{matrix} ]}^{T}$ | ${\frac{1}{2} [ \begin{matrix}1 & {e}^{j \frac{24 π}{16}} & {e}^{j \frac{18 π}{16}} & {e}^{j \frac{23 π}{16}}\end{matrix} ]}^{T}$ |
| 25 | ${\frac{1}{2} [ \begin{matrix}1 & {e}^{j \frac{6 π}{16}} & {e}^{j \frac{27 π}{16}} & {e}^{j \frac{1 π}{16}}\end{matrix} ]}^{T}$ | ${\frac{1}{2} [ \begin{matrix}1 & {e}^{j \frac{22 π}{16}} & {e}^{j \frac{10 π}{16}} & {e}^{j \frac{0 π}{16}}\end{matrix} ]}^{T}$ |
| 26 | ${\frac{1}{2} [ \begin{matrix}1 & {e}^{j \frac{15 π}{16}} & {e}^{j \frac{9 π}{16}} & {e}^{j \frac{23 π}{16}}\end{matrix} ]}^{T}$ | ${\frac{1}{2} [ \begin{matrix}1 & {e}^{j \frac{7 π}{16}} & {e}^{j \frac{17 π}{16}} & {e}^{j \frac{7 π}{16}}\end{matrix} ]}^{T}$ |
| 27 | ${\frac{1}{2} [ \begin{matrix}1 & {e}^{j \frac{22 π}{16}} & {e}^{j \frac{26 π}{16}} & {e}^{j \frac{16 π}{16}}\end{matrix} ]}^{T}$ | ${\frac{1}{2} [ \begin{matrix}1 & {e}^{j \frac{6 π}{16}} & {e}^{j \frac{13 π}{16}} & {e}^{j \frac{19 π}{16}}\end{matrix} ]}^{T}$ |
| 28 | ${\frac{1}{2} [ \begin{matrix}1 & {e}^{j \frac{2 π}{16}} & {e}^{j \frac{23 π}{16}} & {e}^{j \frac{25 π}{16}}\end{matrix} ]}^{T}$ | ${\frac{1}{2} [ \begin{matrix}1 & {e}^{j \frac{4 π}{16}} & {e}^{j \frac{7 π}{16}} & {e}^{j \frac{11 π}{16}}\end{matrix} ]}^{T}$ |
| 29 | ${\frac{1}{2} [ \begin{matrix}1 & {e}^{j \frac{9 π}{16}} & {e}^{j \frac{5 π}{16}} & {e}^{j \frac{15 π}{16}}\end{matrix} ]}^{T}$ | ${\frac{1}{2} [ \begin{matrix}1 & {e}^{j \frac{11 π}{16}} & {e}^{j \frac{21 π}{16}} & {e}^{j \frac{1 π}{16}}\end{matrix} ]}^{T}$ |
| 30 | ${\frac{1}{2} [ \begin{matrix}1 & {e}^{j \frac{8 π}{16}} & {e}^{j \frac{15 π}{16}} & {e}^{j \frac{7 π}{16}}\end{matrix} ]}^{T}$ | ${\frac{1}{2} [ \begin{matrix}1 & {e}^{j \frac{6 π}{16}} & {e}^{j \frac{31 π}{16}} & {e}^{j \frac{21 π}{16}}\end{matrix} ]}^{T}$ |
| 31 | ${\frac{1}{2} [ \begin{matrix}1 & {e}^{j \frac{26 π}{16}} & {e}^{j \frac{7 π}{16}} & {e}^{j \frac{1 π}{16}}\end{matrix} ]}^{T}$ | ${\frac{1}{2} [ \begin{matrix}1 & {e}^{j \frac{10 π}{16}} & {e}^{j \frac{15 π}{16}} & {e}^{j \frac{25 π}{16}}\end{matrix} ]}^{T}$ |

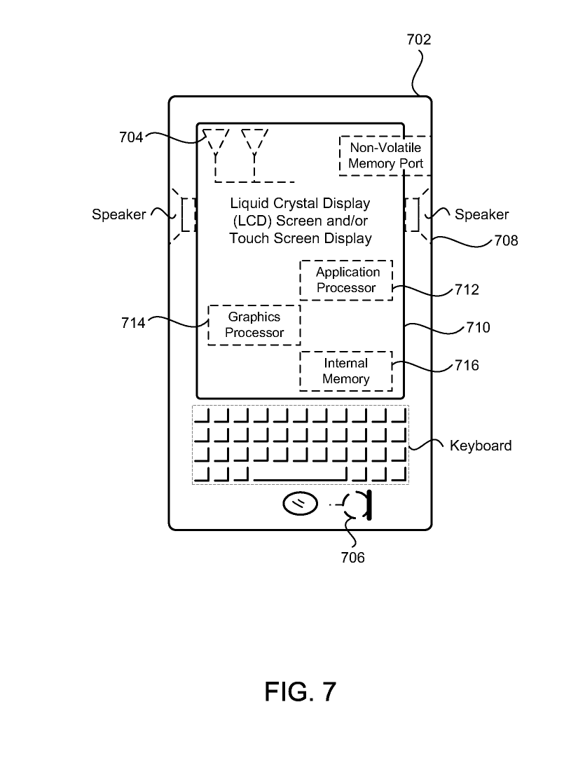

FIG. 6 illustrates a method for enhancing performance of multi-user multiple input multiple output (MU-MIMO) radio links. The method can include the operation of scrambling coded bits in codewords to be transmitted on a physical channel, as in block 510. Another operation can be modulating scrambled bits to generate complex-valued modulation symbols in a transmission, as in block 520.

An increased number of codewords can be provided in a codebook to reduce the channel state information (CSI) quantization error, as in block 530. The complex-valued modulation symbols of the transmission can be precoded using the codebook, as in block 540. The complex-valued modulation symbols can be precoded on each layer for transmission on the antenna ports.

The precoded transmission can be sent to antenna ports, as in block 550 and the precoded transmission can be transmitted using multiple antennas coupled to the antenna ports, as in block 560.

The technology described above can be used in many types of electronic devices and communication systems. One class of devices which may use the transmitters and receivers in the described technology can be mobile communication and computing devices. FIG. 7 provides an example illustration of a mobile device 702, such as a user equipment (UE), a mobile station (MS), a mobile wireless device, a mobile communication device, a tablet, a handset, or other type of mobile wireless device. The mobile device can include one or more antennas 704 configured to communicate with a base station (BS), an evolved Node B (eNB), or other type of wireless wide area network (WWAN) access point. The mobile device can be configured to communicate using at least one wireless communication standard including 3GPP LTE, WiMAX, HSPA, Bluetooth, and WiFi. The mobile device can communicate using separate antennas for each wireless communication standard or shared antennas for multiple wireless communication standards. The mobile device can communicate in a wireless local area network (WLAN), a wireless personal area network (WPAN), and/or a wireless wide area network (WWAN).

FIG. 7 also provides an illustration of a microphone 706 and one or more speakers 708 that can be used for audio input and output from the mobile device. The display screen 710 may be a liquid crystal display (LCD) screen, or other type of display screen such as an organic light emitting diode (OLED) display. The display screen can be configured as a touch screen. The touch screen may use capacitive, resistive, or another type of touch screen technology. An application processor 712 and a graphics processor 714 can be coupled to internal memory 716 to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media can include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A system for enhancing performance of multi-user multiple input multiple output (MU-MIMO) radio links, comprising:
a scrambling module to scramble coded bits in codewords to be transmitted in a transmission;
a modulation mapper to modulate the scrambled coded bits to generate modulation symbols in the transmission;
a precoding module to precode modulation symbols for the transmission
a feedback module using a codebook with an increased number of codewords to reduce a channel state information (CSI) quantization error in a transmission from a plurality of antennas coupled to the precoding module and configured to transmit the precoded transmission to multiple users.

2. The system as in claim 1, wherein the codebook has an increased number of codewords as compared to a 4Tx codebook.

3. The system as in claim 1, wherein a number of entries in the codebook is greater than 32 codebook entries.

4. The system as in claim 3, wherein six bits are transmitted as a precoding matrix indicator (PMI) to identify an entry in the codebook for each codeword.

5. The system of claim 4, wherein two most significant bits of the six bits are transmitted with an RI (rank indicator) and a remaining four bits are transmitted as a PMI in a channel quality indication (CQI) on a physical uplink control channel.

6. The system as in claim 1, wherein the codebook includes entries to jointly address communication with wireless devices employing at least one of: closely spaced ULA antennas, closely spaced cross polarization antennas, largely spaced cross polarization antennas, and geographically separated antennas.

7. The system as in claim 1, further comprising adding additional DFT (Discrete Fourier Transform) vectors to a 4Tx codebook for communication with wireless devices employing closely spaced ULA (Uniform Linear Array) antennas and closely spaced cross polarization antennas.

8. The system as in claim 1, further comprising adding additional non-DFT (non-Discrete Fourier Transform) vectors to a 4Tx codebook to improve performance of communication with wireless devices employing closely spaced cross polarization antennas.

9. The system as in claim 1, further comprising adding a non-constant modulus codeword to the codebook for largely spaced cross polarization antennas or geographically separated antennas.

10. The system as in claim 1, wherein the precoding module is configured to precode complex-valued modulation symbols on each layer for transmission on antenna ports coupled to the plurality of antennas.

11. The system of claim 1, further comprising a mobile device configured to connect to at least one of a wireless local area network (WLAN), a wireless personal area network (WPAN), and a wireless wide area network (WWAN), wherein the mobile device includes an antenna, a touch sensitive display screen, a speaker, a microphone, a graphics processor, an application processor, internal memory, a non-volatile memory port, and combinations thereof.

12. A method for enhancing performance of multi-user multiple input multiple output (MU-MIMO) radio links, comprising:
scrambling coded bits in codewords to be transmitted on a physical channel;
modulating scrambled bits to generate complex-valued modulation symbols in a transmission;
providing an increased number of codewords in a codebook to reduce the channel state information (CSI) quantization error;
precoding the complex-valued modulation symbols of the transmission using the codebook;
sending the precoded transmission to antenna ports; and
transmitting the precoded transmission using multiple antennas coupled to the antenna ports.

13. The method as in claim 12, wherein providing an increased number of codewords to the codebook further comprises adding an increased number of codewords as compared to a 4Tx codebook.

14. The method as in claim 12, further comprises increasing a number of bits representing entries in of the codebook to 5 bits or 6 bits.

15. The method as in claim 14, further comprising increasing the number of bits representing entries in the codebook to enable the codebook to reduce CSI quantization error in communication with wireless devices employing at least one of: closely spaced ULA antennas, closely spaced cross polarization antennas, largely spaced cross polarization antennas, and geographically separated antennas.

16. The method as in claim 12, further comprising adding DFT vectors into an existing 4Tx codebook for communication with a wireless device employing closely spaced ULA antennas.

17. The method as in claim 12, further comprising adding non-DFT vectors to the codebook to further improve a performance of communication with wireless devices employing closely spaced cross polarization antennas.

18. The method as in claim 12, further comprising adding a non-constant modulus codeword to the codebook for communication with wireless devices employing largely spaced cross polarization antennas or geographically separated antennas.

19. The method as in claim 12, wherein precoding further comprises precoding of complex-valued modulation symbols on each layer for transmission on the antenna ports.

20. The method as in claim 12, further comprising using a multiple transmitter devices and multiple receivers to form multiple radio links.

21. The method as in claim 20, wherein using a multiple transmitter and receiver configuration further comprises using a four transmitter (4Tx) and four receiver combination.

22. A computer program product, comprising a computer usable medium having a computer readable program code embodied therein, the computer readable program code adapted to execute the method of claim 12.

23. A system for enhancing performance of a multi-user multiple input multiple output (MU-MIMO) radio links, comprising:
a scrambling module to scramble coded bits in codewords to be transmitted on a physical channel;
a modulation mapper to modulate the scrambled coded bits to generate complex-valued modulation symbols in a transmission;
a layer mapper module to map the complex-valued modulation symbols to antenna ports;
a precoding module to precode the complex-valued modulation symbols for the transmission using an extended codebook with an increased number of codewords to reduce the channel state information (CSI) quantization error; and
antennas coupled to the antenna ports to receive the precoded transmission for multiple users for transmission.

24. The system as in claim 23, wherein the extended codebook has an increased number of codewords as compared to a 4Tx codebook.
